(19) United States
(12) Patent Application Publication
(10) Pub. No.: US 2009/0107769 A1
(43) Pub. Date: Apr. 30, 2009

(54) OIL LUBRICATING STRUCTURE

(75) Inventors: Akihiro Sato, Nagoya-shi (JP); Kazutoshi Motoike, Okazaki-shi (JP); Junji Matsushita, Anjo-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: TOYOTA JIDOSHA KABUSHIKI KAISHA, Toyota-shi (JP); AISIN AW CO., LTD., Anjo-shi (JP)

(21) Appl. No.: 12/258,776

(22) Filed: Oct. 27, 2008

(30) Foreign Application Priority Data
Oct. 29, 2007 (JP) 2007-280376

(51) Int. Cl. F16N 23/00; F16N 31/02

(52) U.S. Cl. 184/6.2; 184/106

(57) ABSTRACT

An oil lubricating structure includes a main body case having a housing chamber in which an element requiring a supply of oil is housed, an oil reservoir which is provided below the main body case and has an oil chamber in which oil collects, an oil supply portion which has an inlet port through which oil is drawn in from the oil chamber and which supplies oil collected in the oil chamber to the element requiring a supply of oil through the inlet port, and a duct member provided in the oil chamber. An oil return hole is provided which is formed in a bottom surface of the main body case toward the front of the oil reservoir and through which oil returns to the oil reservoir from the main body case. One end portion of the duct member is connected to the oil return hole and the other end portion of the duct member is positioned farther to the rear than the inlet port.

### INCORPORATION BY REFERENCE

The disclosure of Japanese Patent Application No. 2007-280376 filed on Oct. 29, 2007, including the specification, drawings and abstract is incorporated herein by reference in its entirety.

### BACKGROUND OF THE INVENTION

1. Field of the Invention

The invention relates to an oil lubricating structure, and more particularly, to an oil lubricating structure suitable for supplying oil drawn in from an oil reservoir to an element requiring a supply of oil, and then returning the oil to the oil reservoir again.

2. Description of the Related Art

Typically in an oil lubricating structure of a vehicle such as an automobile, an oil pan which serves as an oil reservoir is attached to a lower portion of a main body case of a transmission. Oil collected in the oil pan is drawn up by an oil pump through an inlet port formed in a strainer and supplied to elements requiring a supply of oil, such as transmission gears that make up part of the transmission. The oil then moves downward along the main body case while cooling or lubricating the elements requiring a supply of oil and eventually returns to the oil pan through oil return holes formed in the lower portion of the main body case.

Japanese Patent Application Publication No. 2006-266306 (JP-A-2006-266306) describes a hybrid vehicle having this kind of oil lubricating structure, in which a first motor-generator, a power split device, a second motor-generator, and a shift apparatus, all of which are elements requiring a supply of oil, are arranged from the front of the vehicle toward the rear of the vehicle on the same axis in a main body case. Oil return holes are provided through which oil used to cool or lubricate the elements requiring a supply of oil returns to an oil pan provided on a lower portion of the main body case.

In this oil lubricating structure described in JP-A-2006-266306, the oil pan is mounted to a lower portion of the main body case in a position below the second motor-generator. Oil used to cool and lubricate the power split device and the first motor-generator positioned forward of and above the oil pan returns to the oil pan through an oil return hole formed in the bottom surface of the main body case toward the front of the oil pan. Oil used to cool and lubricate the second motor-generator positioned above the oil pan and the shift apparatus positioned above and to the rear of the oil pan returns to the oil pan through an oil return hole formed in the bottom surface of the main body case toward the rear of the oil pan.

However, with this kind of related oil lubricating structure, an oil return hole is formed in the bottom surface of the main body case toward the front of the oil pan so when the vehicle is braked suddenly or is traveling downhill, in which case the oil pan tilts forward with the main body case, oil that has collected in the oil pan may flow back to the first motor-generator and the power split device through the oil return holes formed in the bottom surface of the main body case toward the front of the oil pan. If this happens, the amount of oil in the oil pan may drastically decrease such that air may be drawn into hydraulic equipment, such as an oil pump or a valve body, through the inlet port, and a sufficient amount of oil may not be able to be supplied to the first motor-generator and power split device.

### SUMMARY OF THE INVENTION

In view of the foregoing problems, this invention provides an oil lubricating structure capable of inhibiting air from being drawn in through an inlet port when an oil reservoir tilts forward with a main body case when a vehicle is braked suddenly or is traveling downhill.

Therefore, one aspect of the invention relates to an oil lubricating structure that includes a main body case that has a housing chamber in which an element requiring a supply of oil is housed, an oil reservoir which is provided below the main body case and has an oil chamber in which oil collects, an oil supply portion which has an inlet port through which oil is drawn in from the oil chamber, and which supplies oil collected in the oil chamber to the element requiring a supply of oil through the inlet port, and a duct member provided in the oil chamber. An oil return hole is provided which is formed in a bottom surface of the main body case toward the front of the oil reservoir and through which oil returns to the oil reservoir from the main body case. Further, one end portion of the duct member is connected to the oil return hole and the other end portion of the duct member is positioned farther to the rear than the inlet port.

According to this oil lubricating structure, the duct member is provided in the oil chamber and the one end portion of the duct member is connected to the oil return hole while the other end portion of the duct member is positioned farther to the rear than the inlet port. Accordingly, even if the oil reservoir tilts forward with the main body case when the vehicle is braked suddenly or is traveling downhill, oil will not easily flow into the other end portion of the duct member from the oil chamber so oil can be inhibited from flowing from the other end portion of the duct member back into the housing chamber. As a result, the amount of oil in the oil reservoir will not drastically decrease so air can be inhibited from being drawn in through the inlet port.

Also, when the vehicle is traveling uphill, in which case the oil reservoir tilts backward with the main body case, and the oil return hole is formed in the main body case toward the rear of the oil reservoir, oil may flow from the oil chamber back into the housing chamber through this oil return hole. With the invention, the one end portion of the duct member is connected to the oil return hole and the other end portion of the duct member is positioned farther to the rear than the inlet port. Therefore, air can be inhibited from being drawn into the oil supply portion by, for example, measuring in advance the amount of oil in the oil reservoir when the main body case is tilted backward and positioning the inlet port so that it will be submerged in oil at that time, e.g., positioning the inlet port toward the back of the oil reservoir.

Accordingly, the invention provides an oil lubricating structure capable of inhibiting air from being drawn in through the inlet port when the oil reservoir tilts forward with the main body case when the vehicle is suddenly braked or is traveling downhill.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a sectional view of a hybrid vehicle drive apparatus to which an oil return structure according to a first example embodiment of the invention has been applied;

FIG. 2 is a skeleton view of a shift apparatus according to the first example embodiment of the invention;

FIG. 3 is a sectional view showing a frame format of the internal structure of an oil pan according to the first example embodiment of the invention;

FIG. 4 is a view showing a frame format of an oil circulation path according to the first example embodiment of the invention;

FIG. 5A is a view illustrating a case in which a case and the oil pan according to the first example embodiment of the invention are tilted forward, when no duct member is provided;

FIG. 5B is a view illustrating a case in which the case and the oil pan according to the first example embodiment of the invention are tilted forward, when a duct member is provided;

FIG. 5C is a view illustrating a case in which the case and the oil pan according to the first example embodiment of the invention are tilted backward, when an inlet port is formed in a front portion of a strainer;

FIG. 5D is a view illustrating a case in which the case and the oil pan according to the first example embodiment of the invention are tilted backward, when an inlet port is formed in a rear portion of the strainer; and

FIG. 6 is a top view showing a frame format of the arrangement of a duct member of an oil lubricating structure according to a second example embodiment of the invention.

### DETAILED DESCRIPTION OF THE EMBODIMENTS

Example embodiments of the present invention will be described in greater detail below with reference to the accompanying drawings.

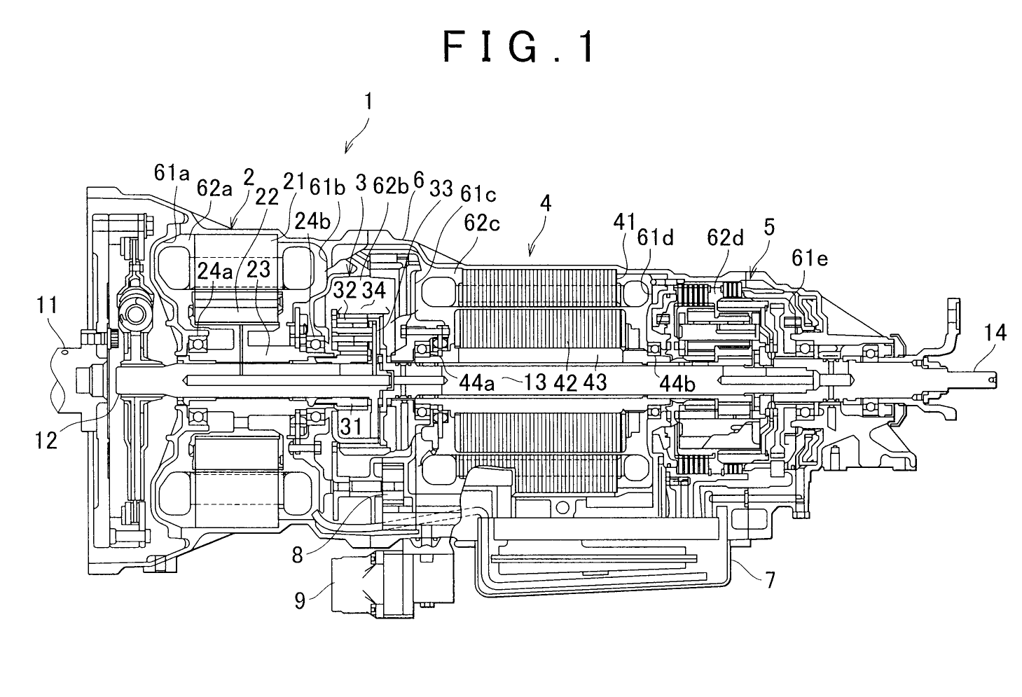

FIGS. 1 to 5D are views of a first example embodiment of the oil lubricating structure of the invention, and show an example in which the invention is applied to a hybrid vehicle drive apparatus.

First the structure will be described. As shown in FIG. 1, a hybrid vehicle drive apparatus 1 is a two-motor type hybrid vehicle drive apparatus. The front end portion shown on the left side of the drawing is connected to an engine, not shown, via a crankshaft 11, and the rear end portion shown on the right side of the drawing is connected to a propeller shaft, also not shown. The hybrid vehicle drive apparatus I has a first motor-generator 2, a power split device 3, a second motor-generator 4, and a shift apparatus 5, all of which are elements requiring a supply of oil that are housed inside a case 6 which serves as the main body case. The first motor-generator 2, the power split device 3, the second motor-generator 4, and the shift apparatus 5 are all provided on the same axis from the front end portion toward the rear end portion.

The inside of the case 6 is divided into housing chambers 62a, 62b, 62c, and 62d by partition walls 61a, 61b, 61c, 61d, and 61e. The first motor-generator 2 is housed in the housing chamber 62a, the power split device 3 is housed in the housing chamber 62b, the second motor-generator 4 is housed in the housing chamber 62c, and the shift apparatus 5 is housed in the housing chamber 62d. Also, an oil pan 7 which serves as the oil reservoir is provided on the lower portion of the case 6. This oil pan 7 is positioned beneath the second motor-generator 4.

An input shaft 12 is arranged extending through the rotational center portions of the first motor-generator 2 and the power split device 3. An intermediate shaft 13 is arranged extending through the rotational center portions of the second motor-generator 4 and the shift apparatus 5. Also, an output shaft 14 is provided on the same axis as the input shaft 12 and the intermediate shaft 13, at the rear end portion of the intermediate shaft 13. Part of this output shaft 14 protrudes from the rear of the case 6.

The input shaft 12 is connected at one end to the crankshaft 11 and at the other end to the power split device 3 so as to transmit driving force from the engine to the power split device 3. The intermediate shaft 13 is connected at one end to the input shaft 12 via the power split device 3 and at the other end to the output shaft 14 so as to transmit power from the input shaft 12 to the output shaft 14. The output shaft 14 is connected to the propeller shaft to transmit the driving force of the engine, which has been transmitted via the input shaft 12 and the intermediate shaft 13, to rear wheels via a differential gear unit, not shown.

Also, a mechanical oil pump 8, which is driven by the driving force of the engine, is provided between the power split device 3 and the second motor-generator 4. In addition, an electric oil pump 9, which is driven using power supplied from a battery, not shown, is arranged below the mechanical pump 8.

Either the mechanical oil pump 8 or the electric oil pump 9 is used, depending on whether the engine is operating or stopped. More specifically, oil is drawn up from the oil pan 7 by the mechanical oil pump 8 while the engine is operating, and oil is drawn up from the oil pan 7 by the electric oil pump 9 while the engine is stopped. Incidentally, either the mechanical oil pump 8 or the electric oil pump 9 can be applied but to facilitate the description, this example embodiment will be described using the mechanical oil pump 8.

The first motor-generator 2 has a stator 21 that is fixed to the inside wall of the case 6, and a rotor 22 that is supported by the partition walls 61a and 61b of the case 6. There is a gap of a predetermined distance between the stator 21 and the rotor 22. The rotor 22 has a hollow rotor shaft 23 and is rotatably supported by the partition walls 61a and 61b via bearings 24a and 24b with the input shaft 12 extending through the hollow portion of the rotor shaft 23. Also, a coil is wound around the stator 21, and a plurality of laminated plates which have permanent magnets imbedded in them are provided on the rotor 22.

The second motor-generator 4 also has a stator 41 and a rotor 42 with a hollow rotor shaft 43, similar to the first motor-generator 2, and is rotatably supported by the partition walls 61c and 61d via bearings 44a and 44b with the intermediate shaft 13 extending through the hollow portion of the rotor shaft 43.

The first motor-generator 2 is designed so to either charge the battery using power generated when the first motor-generator 2 is driven by the engine, or supply the power generated when the first motor-generator 2 is driven by the engine to the second motor-generator 4, depending on the running state of the vehicle. The first motor-generator 2 also functions as a starter when the engine is started. Also, the second motor-generator 4 is designed to assist the engine in providing driving force or run the vehicle on its own using either power stored in the battery or power generated by the first motor-generator 2.

The power split device 3 is a planetary gear which has a hollow sun gear 31 connected to the rotor shaft 23 of the first motor-generator 2, pinion gears 32 that are in mesh with the sun gear 31, a carrier 33 which rotatably supports the pinion gears 32 and is connected to the input shaft 12, and a ring gear 34 which is connected to the intermediate shaft 13 and is in mesh with the pinion gears 32 via internal teeth.

The power split device 3 is designed to distribute driving force to the first motor-generator 2 that is connected to the sun gear 31, and the shift apparatus 5 and the second motor-generator 4 that are connected via the intermediate shaft 13 to the ring gear 34. This is achieved by having the carrier 33 rotate from the driving force transmitted from the input shaft 12 and the pinion gears 32 revolve around the sun gear 31 as the carrier 33 rotates. The rotation of the pinion gears 32 is then transmitted to the sun gear 31 and the ring gear 34.

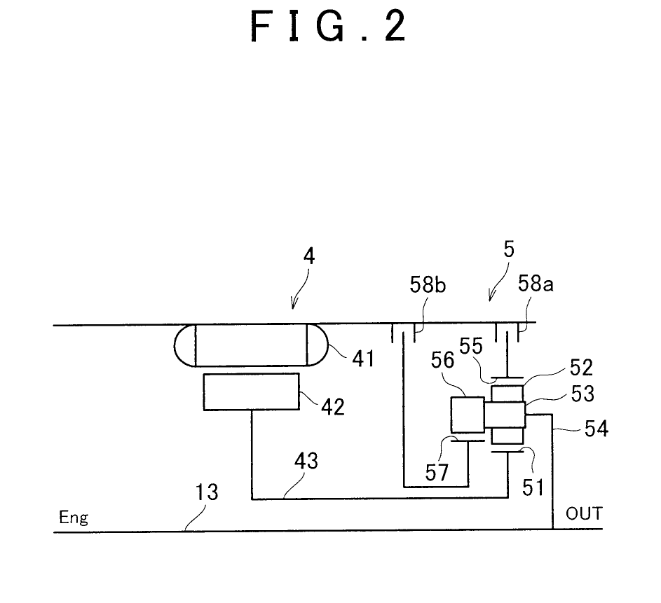

FIG. 2 is a skeleton view of the shift apparatus 5. This shift apparatus 5 is formed of a so-called Ravigneaux type planetary gear which combines a first planetary gear with a second planetary gear that has long pinion gears which also serve as part of the first planetary gear. The first planetary gear has a hollow first sun gear 51 that is connected to the rotor shaft 43 of the second motor-generator 4, first pinion gears 52 that are in mesh with the first sun gear 51, second pinion gears 53 that are in mesh with the first pinion gears 52, a carrier 54 which rotatably supports the first pinion gears 52 and the second pinion gears 53 and is connected to the intermediate shaft 13, and a ring gear 55 that is in mesh with the second pinion gears 53 via internal teeth. The first pinion gears 52 have larger diameters than the second pinion gears 53.

Also, the second planetary gear has third pinion gears 56 which are aligned on the same axis as the second pinion gears 53 and have larger diameters than the second pinion gears 53, and a second sun gear 57 that is in mesh with the third pinion gears 56. That is, the long pinion gears are formed by connecting the second pinion gears 53 with the third pinion gears 56. Also, the shift apparatus 5 has brakes 58a and 58b. The ring gear 55 is able to be braked by the brake 58a and the second sun gear 57 is able to be braked by the brake 58b.

The shift apparatus 5 switches into high gear when the second sun gear 57 is braked against rotation by the brake 58b while the ring gear 55 is allowed to rotate. On the other hand, the shift apparatus 5 switches into low gear when the second sun gear 57 is allowed to rotate while the ring gear 55 is braked against rotation by the brake 58a. Also, when both the ring gear 55 and the second sun gear 57 are allowed to rotate, the output from the second motor-generator 4 is not transmitted to the intermediate shaft 13.

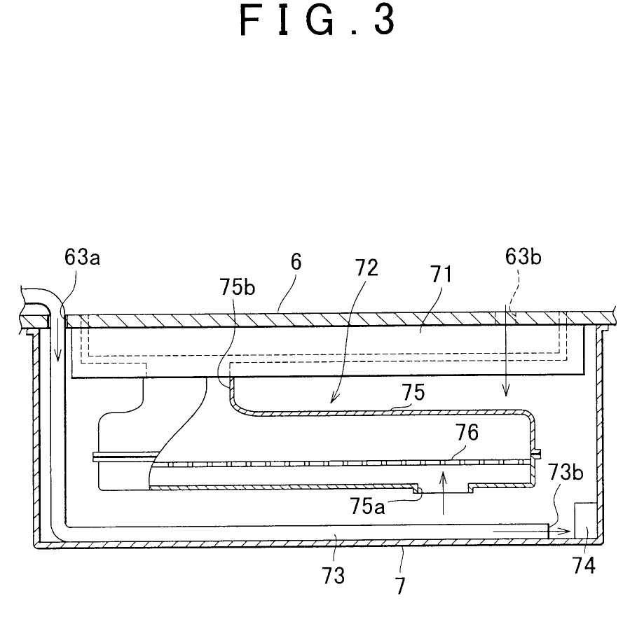

FIG. 3 is a view showing the internal structure of the oil pan 7. The oil pan 7 collects oil used to cool and lubricate the first motor-generator 2, the power split device 3, the second motor-generator 4, and the shift apparatus 5. A valve body 71, a strainer 72, a duct member 73, and a magnetic member 74 are arranged inside the oil pan 7. Also, an oil return hole 63a is provided in the bottom surface of the case 6 toward the front of the oil pan 7 and an oil return hole 63b is provided in the bottom surface of the case 6 toward the back of the oil pan 7. These oil return holes 63a and 63b extend through the bottom surface of the case 6 to communicate the housing chambers 62a and 62c with the inside of the oil pan 7.

The strainer 72 is connected to a lower portion of the valve body 71 and has a strainer case 75 and a filter 76 provided inside the strainer case 75. Also, an inlet port 75a is formed in the bottom wall of the strainer case 75, and a discharge port 75b from which oil is discharged into the valve body 71 is formed in an upper portion of the strainer case 75.

The inlet port 75a is positioned at the rear portion of the strainer case 75 so that even if the oil pan tilts backward with the case 6, it will still be submerged in oil in the oil pan 7. The filter 76 is formed of metal mesh and crimped to the strainer case 75. This filter 76 filters oil that is drawn in through the inlet port 75a.

Also, the valve body 71 is provided on a lower portion of the case 6 and supplies oil to the first motor-generator 2, the power split device 3, the second motor-generator 4, and the shift apparatus 5 from the mechanical oil pump 8 through a plurality of oil passages. The valve body 71 has a plurality of pressure-regulating valves, not shown, which open and close the plurality of oil passages. Operation of the first motor-generator 2, the power split device 3, the second motor-generator 4, and the shift apparatus 5 is controlled by adjusting the amount of oil supplied to these apparatuses and devices by controlling the plurality of pressure-regulating valves open and closed.

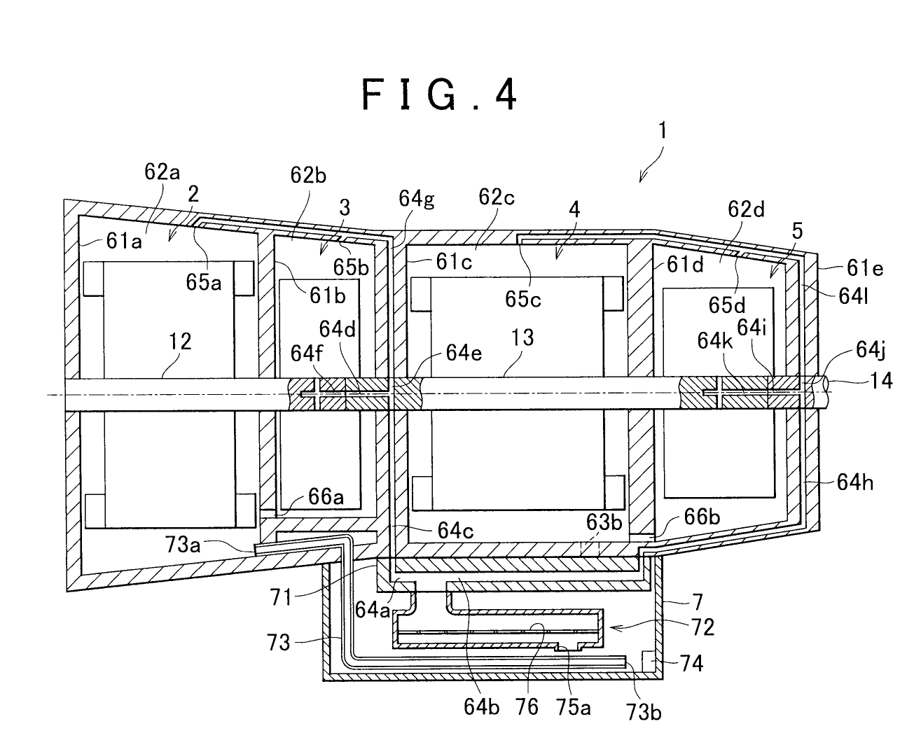

A duct member 73 is provided in the oil pan 7. One end portion 73a (see FIG. 4) of this duct member 73 is connected to the oil return hole 63a. The other end portion 73b of the duct member 73 extends from the one end portion 73a to behind (i.e., farther to the rear than) the inlet port 75a. This duct member 73 is formed from resinous material and is able to bend.

Also, the magnetic member 74 provided in the oil pan 7 is provided near the other end portion 73b of the duct member 73. This magnetic member 74 attracts iron particles mixed in with the oil that flows back to the oil pan 7 through the duct member 73.

Incidentally, the phrase “near the other end portion 73b of the duct member 73” refers to an area where the magnetic force of the magnetic member 74 is strong enough to sufficiently attract the iron particles in the oil discharged from the duct member 73. Therefore, because the iron particles in the oil discharged from the other end portion 73b of the duct member 73 are always affected by the magnetic force of the magnetic member 74, they can be effectively attracted, which enables the oil to be kept reliably clean.

Incidentally, the magnetic member 74 may be fixed to the oil pan 7 or detachable with respect to the oil pan 7. Detachably fixing the magnetic member 74 to the oil pan 7 enables it to be replaced easily so when the magnetic force of the magnetic member 74 becomes weak, it can be replaced with a new magnetic member 74. Incidentally, in this example embodiment, the magnetic member 74 is attached to the oil pan 7, but it may also be attached to the other end portion 73b of the duct member 73.

Next, the oil circulation path will be described with reference to FIG. 4 which is a view showing a frame format of the oil passages that form the oil circulation path according to the first example embodiment of the invention.

As shown in FIG. 4, oil collected in the oil pan 7 is drawn up through the strainer 72 by operating the mechanical oil pump 8, and the pressure of that oil is then regulated by a pressure-regulating valve inside the valve body 71. The pressure-regulated oil then branches off along the oil passages 64a and 64b formed inside the valve body 71. The oil that passes through the oil passage 64a flows through the oil passage 64c formed in the partition wall 61c after which it branches off again along the oil passages 64d and 64e formed in the intermediate shaft 13.

The oil that passes through the oil passage 64d flows through an oil passage 64f, which is formed in the input shaft 12 so as to communicate with the oil passage 64d, to be supplied into the power split device 3, thereby cooling and lubricating the power split device 3 from the inside.

The oil that passes through the oil passage 64e flows through an oil passage 64g formed in the partition wall 61c to be supplied to the first motor-generator 2 and the power split device 3 via supply ports 65a and 65b formed above the housing chambers 62a and 62b, thereby cooling and lubricating the first motor-generator 2 and the power split device 3 from above.

The housing chambers 62a and 62b are communicated by a communication hole 66a formed in the partition wall 61b such that the oil supplied to the power split device 3 and the oil supplied to the first motor-generator 2 combine and return to the oil pan 7 via the duct member 73.

Meanwhile, the oil that passes through the oil passage 64b flows through an oil passage 64h formed in the partition wall 61e and branches off again along oil passages 64i and 64j formed inside the output shaft 14. The oil that passes through the oil passage 64i flows through an oil passage 64k, which is formed in the intermediate shaft so as to communicate with the oil passage 64i, to be supplied into the shift apparatus 5, thereby cooling and lubricating the shift apparatus 5 from the inside.

The oil that passes through the oil passage 64j flows through an oil passage 644l formed in the partition wall 61e to be supplied to the second motor-generator 4 and the shift apparatus 5 via supply ports 65c and 65d formed above the housing chambers 62c and 62d, thereby cooling and lubricating the second motor-generator 4 and the shift apparatus 5 from above.

The housing chambers 62c and 62d are communicated by a communication hole 66b formed in the partition wall 61d such that the oil supplied to the shift apparatus 5 and the oil supplied to the second motor-generator 4 combine and return to the oil pan 7 via the oil return hole 63b.

In this way, the oil supplied to the power split device 3 and the first motor-generator 2 positioned toward the front of the vehicle returns to the oil pan 7 via the duct member 73, while the oil supplied to the shift apparatus 5 and the second motor-generator 4 positioned toward the center of the vehicle returns to the oil pan 7 via the oil return hole 63b. Incidentally, oil supply portion of the invention is formed by the oil path 64, the strainer 72, the valve body 71, and the mechanical oil pump 8 described above.

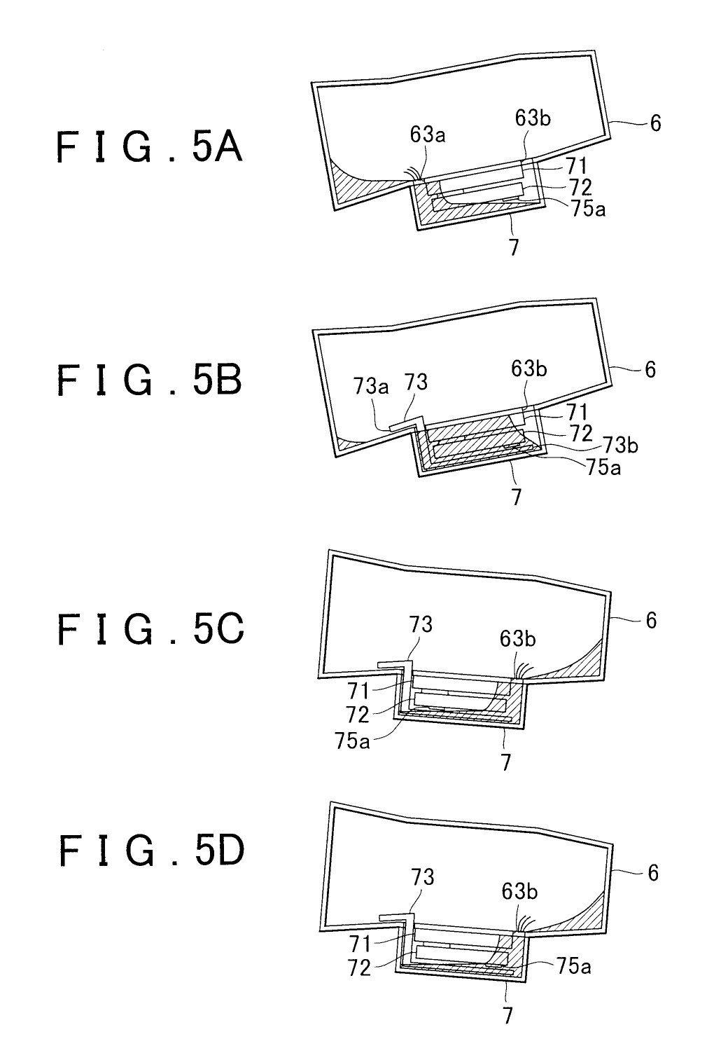

The state of the oil inside the oil pan 7 when the case 6 and the oil pan 7 are tilted forward and backward will now be described with reference to FIGS. 5A to 5D. Incidentally, FIG. 5A is a view illustrating a case in which the case 6 and the oil pan 7 is tilted forward and the duct member 73 is not provided, and FIG. 5B is a view illustrating a case in which the case 6 and the oil pan 7 is tilted forward and the duct member 73 is provided. Also, FIG. 5C is a view illustrating a case in which the case 6 and the oil pan 7 is tilted backward and the inlet port 75a is formed toward the front of the strainer 72, and FIG. 5D is a view illustrating a case in which the case 6 and the oil pan 7 is tilted backward and the inlet port 75a is formed toward the back of the strainer 72.

When the vehicle is braked suddenly, the oil pan 7 tilts forward such that oil in the oil pan 7 collects toward the front from the force of inertia, or when the vehicle is traveling downhill, oil in the oil pan 7 collects toward the front according to the inclination of the oil pan 7, as shown in FIGS. 5A and 5B. When the duct member 73 is not provided in this case, as shown in FIG. 5A, the oil in the oil pan 7 flows back into the case 6 through the oil return hole 63a, causing the amount of oil in the oil pan 7 to drastically decrease such that air may end up being drawn into the mechanical oil pump 8 and the valve body 71 through the strainer 72. As a result, the mechanical oil pump 8 may make an air sucking sound and it is possible that not enough oil will be supplied to the first motor-generator 2, the power split device 3, the second motor-generator 4, and the shift apparatus 5 from the valve body 71.

On the other hand, when the duct member 73 is provided in this case, as shown in FIG. 5B, the other end portion 73b of the duct member 73 is positioned farther to the rear than the inlet port 75a of the strainer 72 so oil in the oil pan 7 does not easily flow into it, thus enabling the amount of oil that flows back into the case 6 from the duct member 73 to be significantly reduced. As a result, the inlet port 75a of the strainer 72 can be kept submerged in oil, which inhibits air from being drawn in through the inlet port 75a and thus inhibits air from being drawn into the mechanical oil pump 8 and the valve body 71.

As shown in FIG. 5C, when the inlet port 75a is formed in the front portion of the strainer 72 and the vehicle is traveling uphill in which case the oil pan 7 tilts backwards such that the oil inside the oil pan 7 flows back into the case 6 through the oil return hole 63b, the amount of oil in the oil pan 7 may drastically decrease such that the inlet port 75a ends up being above the surface of the oil. Accordingly, air may be drawn into the mechanical oil pump 8 and the valve body 71 through the strainer 72. As a result, the mechanical oil pump 8 may produce an air sucking sound and it is possible that not enough oil will be supplied to the first motor-generator 2, the power split device 3, the second motor-generator 4, and the shift apparatus 5 from the valve body 71.

In contrast, with this example embodiment, as shown in FIG. 5D, the inlet port 75a is formed in the rear portion of the strainer 72 so even if the oil pan 7 tilts backwards, the inlet port 75a of the strainer 72 can be kept submerged in oil, which inhibits air from being drawn into the mechanical oil pump 8 and the valve body 71.

In this way, in this example embodiment the duct member 73 is provided in the oil pan 7 and the one end portion 73a of the duct member 73 is connected to the oil return hole 63a provided toward the front of the oil pan 7 while the other end portion 73b of the duct member 73 is positioned farther to the rear than the inlet port 75a. Accordingly, even if the oil pan 7 tilts forward with the case 6 when the vehicle is braked suddenly or is traveling downhill, oil will not easily flow into the other end portion 73b of the duct member 73 from the oil pan 7, so oil can be inhibited from flowing back into the housing chamber 62a from the other end portion 73b of the duct member 73. As a result, the amount of oil in the oil pan 7 will not drastically decrease so air can be inhibited from being drawn in through the inlet port 75a, which in turn inhibits air from being drawn into the mechanical oil pump 8 and the valve body 71.

In addition, oil can be reliably drawn in through the inlet port 75a so a sufficient amount of oil can be supplied to the first motor-generator 2, the power split device 3, the second motor-generator 4, and the shift apparatus 5.

Also, when the vehicle is traveling uphill, in which case the oil pan 7 tilts backward with the case 6, and the oil return hole 63b is formed in the case 6 toward the rear of the oil pan 7, oil may flow up from the oil pan 7 back into the housing chamber 62c through this oil return hole 63b. With the invention, the one end portion 73a of the duct member 73 is connected to the oil return hole 63a and the other end portion 73b of the duct member 73 is arranged farther toward the rear than the inlet port 75a. Therefore, air can be inhibited from being drawn into the mechanical oil pump 8 and the valve body 71 by, for example, measuring in advance the amount of oil in the oil pan 7 when the case 6 is tilted backward and positioning the inlet port 75a so that it will be submerged in oil, e.g., positioning the inlet port 75a at the rear portion of the strainer 72.

Also, the oil pan 7 has the magnetic member 74 and this magnetic member 74 is positioned near the other end portion 73b of the duct member 73. As a result, iron particles that are produced from friction between members that make up each apparatus or device, i.e., the first motor-generator 2, the power split device 3, the second motor-generator 4, and the shift apparatus 5, and return with the oil to the oil pan 7 are attracted by the magnetic member 74 so clean oil can be circulated. Further, providing the magnetic member 74 near the other end portion 73b of the duct member 73 enables iron particles discharged together with the oil from the duct member 73 to be efficiently attracted to the magnetic member 74. Also, the magnetic member 74 can be arranged in a position where the iron particles in the oil can be efficiently attracted to it so it does not need to be dispersed over a wide area in the oil pan 7 or made large, i.e., the magnetic member 74 can be made small.

Moreover, the magnetic member 74 is detachably provided in the oil pan 7 so it can easily be replaced so the ability to attract iron particles can be maintained.

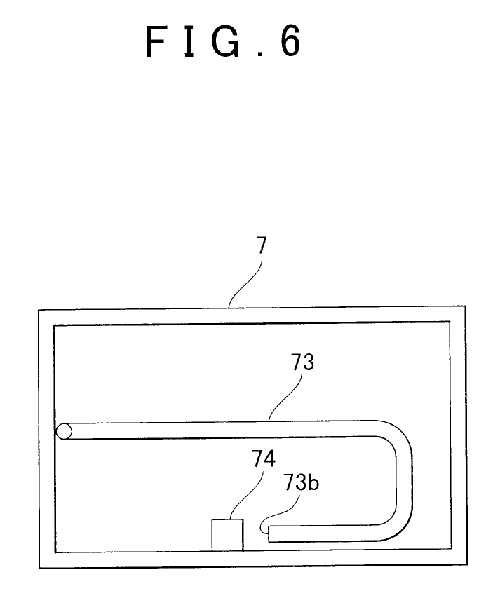

Next, a second example embodiment of the invention will be described. FIG. 6 is a top view showing a frame format of the arrangement of the duct member 73 of an oil lubricating structure according to the second example embodiment of the invention. Incidentally, structure of this second example embodiment that is the same as that of the first example embodiment will be denoted by the same reference numerals and descriptions of that structure will be omitted. Like structure will be described using the same reference characters as in the first example embodiment shown in FIGS. 1 to 5D.

As shown in FIG. 6, the duct member 73 is arranged in the oil pan 7 so that the other end portion 73b is curved forward toward the front of the vehicle. In this case, the magnetic member 74 is mounted in front of the other end portion 73b of the duct member 73 so that it can efficiently attract iron particles mixed in with the oil that returns via the duct member 73. Incidentally, in this example embodiment, the duct member 73 is arranged curved to the side in the oil pan 7 but it may also be arranged curved downward in the oil pan 7. In this case as well, mounting the magnetic member 74 forward of the other end portion 73b of the duct member 73 enables it to efficiently attract iron particles mixed in with the oil that returns via the duct member 73.

As described above, the other end portion 73b of the duct member 73 is arranged curved toward the front in the oil pan 7 so the oil flow outlet of the other end portion 73b of the duct member 73 faces toward the front of the vehicle, which further inhibits oil from flowing back from the oil pan 7 into the housing chamber 62a through the other end portion 73b of the duct member 73.

The duct member 73 according to the example embodiments described above may also has a one-way valve which allows oil to move from the housing chamber 62a into the oil pan 7 but prevents it from moving from the oil pan 7 into the housing chamber 62a.

According to this structure, oil is allowed to flow from the housing chamber 62a into the oil pan 7 but is reliably prevented from flowing from the oil pan 7 back into the housing chamber 62a. As a result, oil is able to reliably return to the oil pan 7 from the case 6, while air can be more reliably inhibited from being drawn in through the inlet port 75a.

Incidentally, in the oil lubricating structures of the example embodiments described above, there is only one oil return hole 63a to which the duct member 73 is attached. However, a plurality of duct members 73 may be attached to a plurality of oil return holes 63a.

Also, in the example embodiments described above, the structure is not limited to the duct member 73 extending all the way to the housing chamber 62a. That is, the invention can be applied as long as the structure is such that the duct member 73 connects the oil return hole 63a to the rear space in the oil pan 7.

As described above, the oil lubricating structure of the invention is effective in that it inhibits air from being drawn in through the inlet port when the oil reservoir tilts forward with the main body case when the vehicle is braked suddenly or is traveling downhill. The oil lubricating structure of the invention is useful as an oil lubricating structure or the like which is suitable for supplying oil that has been drawn up from the oil reservoir to elements requiring a supply of oil and then returning that oil to the oil reservoir again.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. An oil lubricating structure comprising:
a main body case that has a housing chamber in which an element requiring a supply of oil is housed;
an oil reservoir which is provided below the main body case and has an oil chamber in which oil collects;
an oil supply portion which has an inlet port through which oil is drawn in from the oil chamber, and which supplies oil collected in the oil chamber to the element requiring a supply of oil through the inlet port; and
a duct member provided in the oil chamber,
wherein an oil return hole is provided which is formed in a bottom surface of the main body case toward the front of the oil reservoir and through which oil returns to the oil reservoir from the main body case, and
wherein one end portion of the duct member is connected to the oil return hole and the other end portion of the duct member is positioned farther to the rear than the inlet port.

2. The oil lubricating structure according to claim 1, wherein the oil supply portion has a strainer, and the inlet port is provided in the strainer.

3. The oil lubricating structure according to claim 2, wherein the inlet port is positioned toward the rear of the strainer.

4. The oil lubricating structure according to claim 2, wherein the duct member has a one-way valve which allows oil to move from the housing chamber into the oil chamber but prevents oil from moving from the oil chamber into the housing chamber.

5. The oil lubricating structure according to claim 2, wherein the oil reservoir has a magnetic member provided near the other end portion of the duct member.

6. The oil lubricating structure according to claim 5, wherein the magnetic member is provided detachable with respect to the oil reservoir.

7. The oil lubricating structure according to claim 1, wherein the other end portion of the duct member has a curved portion that is curved toward the front.

8. The oil lubricating structure according to claim 7, wherein the duct member has a one-way valve which allows oil to move from the housing chamber into the oil chamber but prevents oil from moving from the oil chamber into the housing chamber.

9. The oil lubricating structure according to claim 7, wherein the oil reservoir has a magnetic member provided near the other end portion of the duct member.

10. The oil lubricating structure according to claim 9, wherein the magnetic member is provided detachable with respect to the oil reservoir.

11. The oil lubricating structure according to claim 1, wherein the duct member has a one-way valve which allows oil to move from the housing chamber into the oil chamber but prevents oil from moving from the oil chamber into the housing chamber.

12. The oil lubricating structure according to claim 1, wherein the oil reservoir has a magnetic member provided near the other end portion of the duct member.

13. The oil lubricating structure according to claim 12, wherein the magnetic member is provided detachable with respect to the oil reservoir.
